(19) United States
(12) Patent Application Publication
(10) Pub. No.: US 2026/0268603 A1
(43) Pub. Date: Sep. 10, 2026

(54) STEREOSCOPIC IMAGE DISPLAY SYSTEM AND 3D SCENE VISUALIZATION METHOD THEREOF

(71) Applicant: Acer Incorporated, New Taipei City (TW)

(72) Inventor: Sergio Cantero Clares, New Taipei City (TW)

(73) Assignee: Acer Incorporated, New Taipei City (TW)

(21) Appl. No.: 19/072,941

(22) Filed: Mar. 6, 2025

(51) Int. Cl. G06T 17/20; G06T 7/593; G06V 10/54; H04N 13/00; H04N 13/282

(52) U.S. Cl. CPC G06T 17/20; G06T 7/593; G06V 10/54; H04N 13/282; H04N 2013/0081

(57) ABSTRACT

A stereoscopic image display system and a 3D scene information generation method thereof are disclosed. The method includes the following steps. A left-eye image and a right-eye image from a stereoscopic image pair are obtained. Monocular depth estimation is performed separately on the left-eye image and the right-eye image to generate a left-eye depth map and a right-eye depth map. Stereoscopic depth information is generated based on disparity information between the left-eye image and the right-eye image. A left-side stereoscopic mesh of the left-eye image is created based on the left-eye depth map, and a right-side stereoscopic mesh of the right-eye image is created based on the right-eye depth map. A 3D scene mesh is generated based on the stereoscopic depth information, the left-side stereoscopic mesh, and the right-side stereoscopic mesh. 3D scene content is output based on the 3D scene mesh.

### BACKGROUND

### Technical Field

This disclosure relates to a stereo image processing technology, and particularly to a stereo image display system and its method for visualizing 3D scene.

### Description of Related Art

With the advancement of display technology, stereo displays supporting stereo vision technology have gradually become widespread. Stereo vision technology allows viewers to perceive the 3D sense in image screens, such as the stereoscopic facial features and depth of field, which traditional 2D images cannot present. The principle of stereo vision technology is to let the viewer's left eye view the left eye image and the viewer's right eye view the right eye image, allowing the viewer to experience a 3D visual effect. 3D displays can provide left eye images and right eye images separately to the viewer's left and right eyes, offering people a visually immersive experience. However, the current market lacks sufficient 3D image content, so even if users have a 3D display, they still cannot fully and freely enjoy the display effects brought by the 3D display. At present, although there are technologies for generating 3D content from monocular image content, they often result in blurred or incomplete image edges. Furthermore, the current existing 3D image content has fixed viewing angles and depths, which is a relatively inflexible 3D visual effect.

### SUMMARY

This disclosure provides a stereo image display system and a method for visualizing 3D scene that may effectively solve the aforementioned problems.

The exemplary embodiment of the disclosure provides a method for visualizing 3D scene, including the following steps. A left eye image and a right eye image are obtained from a stereo image pair. Monocular depth estimation is performed on the left eye image and the right eye image respectively to obtain a left eye depth map and a right eye depth map. Stereo depth information is generated based on the disparity information between the left eye image and the right eye image. A left side 3D mesh of the left eye image is generated based on the left eye depth map, and a right side 3D mesh of the right eye image is generated based on the right eye depth map. A 3D scene mesh is generated according to the stereo depth information, the left side 3D mesh and the right side 3D mesh. 3D scene content is outputted according to the 3D scene mesh.

Another exemplary embodiment of the disclosure provides a stereo image display system, which includes a stereo display and at least one processor. The processor is coupled to the stereo display and configured to perform the following operations. A left eye image and a right eye image are obtained from a stereo image pair. Monocular depth estimation is performed on the left eye image and the right eye image respectively to obtain a left eye depth map and a right eye depth map. Stereo depth information is generated based on the disparity information between the left eye image and the right eye image. A left side 3D mesh of the left eye image is generated based on the left eye depth map, and a right side 3D mesh of the right eye image is generated based on the right eye depth map. A 3D scene mesh is generated according to the stereo depth information, the left side 3D mesh and the right side 3D mesh. 3D scene content is outputted according to the 3D scene mesh.

Based on the above, in embodiments of the disclosure, the 3D scene mesh may be generated according to the depth estimation results of monocular depth estimation and the stereo depth information of the stereo image pair. Therefore, monocular depth estimation may be used to compensate for the occlusion and texture repetition problems in binocular depth estimation, and the stereo depth information of the stereo image pair may also be used to optimize the estimation results of monocular depth estimation. Accordingly, the 3D scene mesh generated based on monocular depth estimation and stereo depth information of the stereo image pair may not only allow users to perceive depth of field that matches the scene type, but also realize high-precision, flexible and efficient 3D scene generation and visualization.

### BRIEF DESCRIPTION OF THE DRAWINGS

FIG. 1 is a schematic diagram of a stereo image display system according to an embodiment of the disclosure.

FIG. 2 is a schematic diagram of a stereo display according to an embodiment of the disclosure.

FIG. 3 is a flowchart of a method for visualizing 3D scene according to an embodiment of the disclosure.

FIG. 4 is a schematic diagram of a method for visualizing 3D scene according to an embodiment of the disclosure.

FIG. 5 is a schematic diagram of generating 3D scene content according to the left eye image and the right eye image in an embodiment of the disclosure.

FIG. 6 is a flowchart of generating 3D scene mesh according to an embodiment of the disclosure.

FIG. 7 is a flowchart of determining texture information according to an embodiment of the disclosure.

FIG. 8 is a schematic diagram of determining texture information according to an embodiment of the disclosure.

FIG. 9 is a flowchart of outputting 3D scene content according to an embodiment of the disclosure.

FIG. 10 is a flowchart of outputting 3D scene content according to an embodiment of the disclosure.

### DESCRIPTION OF THE EMBODIMENTS

Some exemplary embodiments of the disclosure will now be described in detail with reference to the accompanying drawings. The reference numerals used in the following description, when the same reference numerals appear in different drawings, will be considered as the same or similar components. These exemplary embodiments are only a part of the disclosure and do not reveal all possible implementations of the disclosure. More precisely, these exemplary embodiments are merely examples of the methods and systems in the scope of patent claims of the disclosure.

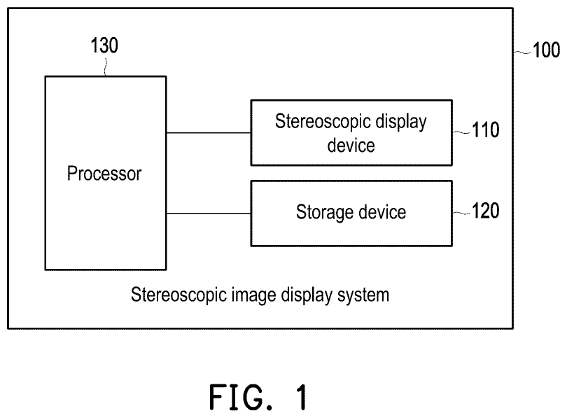

FIG. 1 is a schematic diagram of a stereo image display system according to an embodiment of the disclosure. Referring to FIG. 1, the stereo image display system 100 may include a stereo display 110, a storage device 120, and at least one processor 130. In various embodiments, the stereo image display system 100 may be implemented as an integrated system or a separate system. In some embodiments, the stereo display 110, storage device 120, and processor 130 may be implemented in an all-in-one electronic device, such as a laptop computer, tablet computer, desktop computer, game console, portable electronic device or other personal electronic device. Alternatively, in some embodiments, the stereo display 110 may be connected to a computing device including the storage device 120 and processor 130 through a wired or wireless transmission interface.

The stereo display 110 may allow users to perceive stereoscopic visual effects. In order for users to perceive 3D visual effects through the stereo display 110, the stereo display 110 may, according to its hardware specifications and the 3D display technology it applies, allow the user's left eye and right eye to respectively view different image content corresponding to different viewpoints (i.e., left eye image and right eye image).

In some embodiments, the stereo display 110 may be a naked eye stereoscopic 3D display, for example, it may be implemented as a laptop display, television, desktop monitor or electronic signage, etc. In some embodiments, the left eye image and right eye image may be displayed simultaneously based on stereoscopic image display technology, such as parallax barrier technology, lenticular technology or directional backlight technology. Alternatively, in some embodiments, the stereo display 110 may be a head-mounted display device, for example, it may be implemented as a virtual reality display device or mixed reality display device, etc.

From another perspective, the stereo display 110 may include a Liquid Crystal Display (LCD), Light-Emitting Diode (LED) display, Organic Light-Emitting Diode (OLED) display or other types of displays. This disclosure is not limited to these examples.

The storage device 120 is used to temporarily or permanently store data, such as images, instructions, code, software modules, etc. Specifically, the storage device 120 may include volatile storage circuits. Volatile storage circuits are used to store data in a volatile manner. For example, volatile storage circuits may include random access memory (RAM) or similar volatile storage media. Alternatively, the storage device 120 may include non-volatile storage circuits. Non-volatile storage circuits are used to store data in a non-volatile manner. For example, non-volatile storage circuits may include read-only memory (ROM), solid-state drive (SSD) and/or traditional hard disk drive (HDD) or similar non-volatile storage media. The number of storage devices 120 may be one or more, and the disclosure does not impose any limitation on this.

The processor 130 is connected to the stereo display 110 and the storage device 120. For example, the processor 130 may include a central processing unit (CPU), graphic processing unit (GPU) or other programmable general-purpose or special-purpose microprocessors, digital signal processor (DSP), programmable controller, application specific integrated circuit (ASIC), programmable logic device (PLD) or other similar devices or combinations of these devices. The number of processors 130 may be one or more, and the disclosure does not impose any limitation on this.

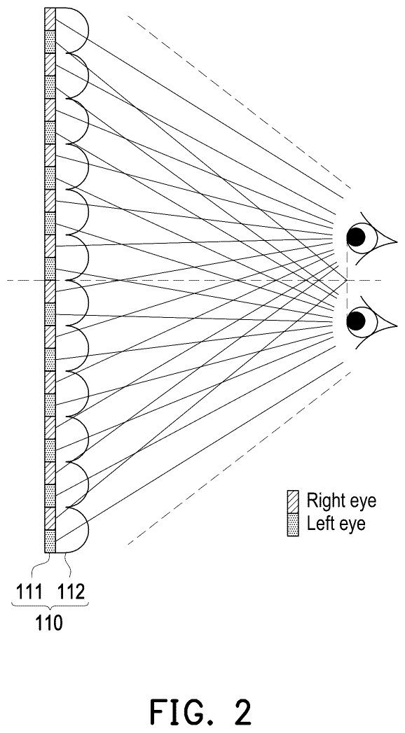

FIG. 2 is a schematic diagram of a stereo display according to an embodiment of the disclosure. Referring to FIG. 2, in some embodiments, the stereo display 110 may be a naked-eye stereo display, which may provide different images for the left eye and right eye through the principle of lens refraction, allowing the viewer to experience a stereoscopic display effect. The stereo display 110 may include a display panel 111 and a lens layer 112. The lens layer 112 is placed above the display panel 111, and the viewer can see the screen content provided by the display panel 111 through the lens layer 112. The stereo display 110 can place the pixels of the first left eye image and the pixels of the first right eye image at the corresponding pixel positions on the display panel 111. The lens layer 112, through light refraction, refracts different display contents (i.e., left eye image and right eye image) to different positions in space, allowing the left eye and right eye to receive two different images with parallax respectively. It is known that in order to place the pixels of the left eye image and the pixels of the right eye image at the corresponding pixel positions on the display panel 111, the left eye image and the right eye image need to undergo image interweaving processing to generate an interwoven frame with the pixels of the left eye image and the pixels of the right eye image arranged alternately.

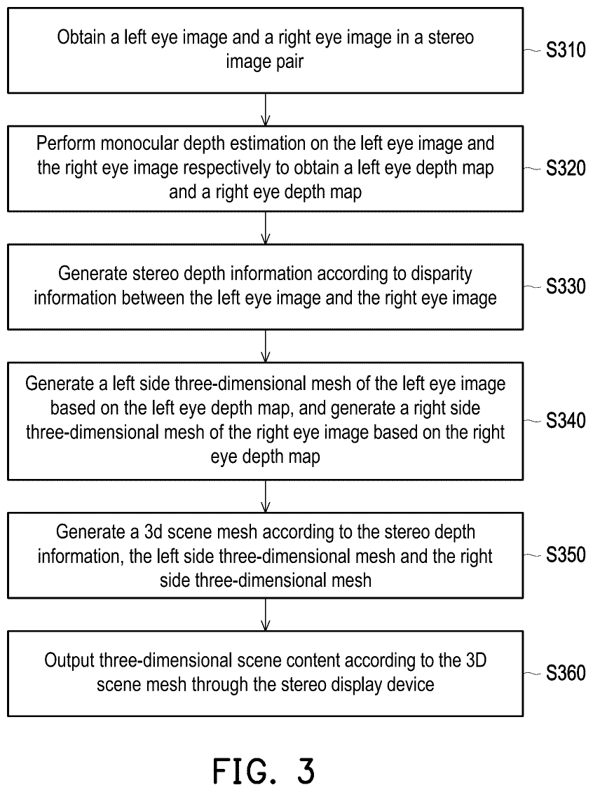

FIG. 3 is a flowchart of a 3D scene visualization method according to an embodiment of the disclosure. Referring to FIG. 3, the operation process of this embodiment is applicable to the stereo image display system 100 in the above-mentioned embodiment. The following will explain the detailed steps of this embodiment in conjunction with the various components in the stereo image display system 100.

In step S310, the processor 130 may obtain a left eye image and a right eye image from a stereo image pair. In some embodiments, the stereo image pair may be produced by various devices, such as a stereo camera module, VR/AR device, or dual-lens module in a mobile device. These dual-lens devices capture the left eye image and right eye image of the scene through a preset baseline distance and camera parameters, forming a stereo image pair with parallax characteristics. Generally, to ensure the accuracy of subsequent processing, the acquisition of the left eye image and right eye image may need to meet the requirements of synchronization, resolution, and format consistency.

In some embodiments, the stereo image pair may be a Side-by-Side (SBS) image that conforms to the stereo image format. The SBS image includes left eye image and right eye image from different viewpoints.

In step S320, the processor 130 may perform monocular depth estimation on the left eye image and right eye image respectively to obtain a left eye depth map and a right eye depth map. Specifically, in some embodiments, the processor 130 may perform a monocular depth estimation on the left eye image and right eye image separately to obtain depth information for the left eye image and right eye image respectively. By executing monocular depth estimation, the processor 130 may estimate the depth information of the captured scene based on a single viewpoint image.

In some embodiments, the processor 130 may input the left eye image into a monocular depth estimation model to obtain the left eye depth map. Additionally, the processor 130 may input the right eye image into a monocular depth estimation model to obtain the right eye depth map. In other words, the processor 130 may use a deep learning model to execute monocular depth estimation on the input frame. The processor 130 may input the input frame (i.e., the left eye image or right eye image) into a trained monocular depth estimation model to obtain the depth map of the input frame.

Alternatively, in some embodiments, the processor 130 may use other vision algorithms to execute monocular depth estimation on the left eye image and right eye image separately. For example, the processor 130 may analyze image features at different scales or motion trajectories of objects in the left eye image or right eye image, etc., to estimate the depth information of the left eye image or right eye image.

It should be noted that the depth values in the depth information obtained through monocular depth estimation have been normalized to be within a preset numerical range. For example, the depth values in the left eye depth map and right eye depth map may range from 0 to 255.

In step S330, the processor 130 may generate stereo depth information based on the disparity information between the left eye image and right eye image. In some embodiments, the stereo depth information may be a depth map. In some embodiments, the disparity information may be obtained through disparity calculation of the left eye image and right eye image, to generate stereo depth information corresponding to the stereo scene based on the disparity information. The stereo depth information may be used to describe the 3D structure and spatial position of objects in the scene, providing a foundation for subsequent mesh generation and visualization.

Regarding disparity calculation, the processor 130 may calculate the disparity value for each pair of corresponding pixels by matching pixel positions in the left eye image and right eye image. This disparity value represents the horizontal displacement of the same object in the left eye image and right eye image, and is inversely proportional to the depth of the object. The formula for calculating disparity is shown in formular (1) below.

$$disp = \frac{IPD \cdot f}{z} \qquad formular ( 1 )$$

wherein disp represents the disparity value, IPD represents the baseline distance of the camera (the distance between the left and right cameras), z represents the depth, and f represents the focal length of the camera.

In some embodiments, the processor 130 may implement disparity calculation through a Stereo Matching Algorithm. The aforementioned stereo matching algorithm is used to perform pixel matching between pixels of the left eye image and pixels of the right eye image, which may include Block Matching, Global Optimization, or deep learning-based methods. Block Matching may be based on texture features of image regions, searching for the best matching position through a sliding window. Global Optimization may be designed based on an Energy Function, considering the balance between matching cost and smoothness constraints.

In step S340, the processor 130 may generate a left side 3D mesh of the left eye image based on the left eye depth map, and generate a right side 3D mesh of the right eye image based on the right eye depth map.

In some embodiments, the processor 130 may map multiple pixels of the left eye image to multiple first 3D coordinates in a 3D coordinate system based on the camera intrinsic parameters and the left eye depth map, to construct the left side 3D mesh of the left eye image. Furthermore, the processor 130 may map multiple pixels of the right eye image to multiple second 3D coordinates in a 3D coordinate system based on the camera intrinsic parameters and the right eye depth map, to construct the right side 3D mesh of the right eye image. The camera intrinsic parameters describe the internal geometry and optical characteristics of the camera, mainly used to define the relationship between the image plane and the camera coordinate system. In some embodiments, the aforementioned 3D coordinate system may be the camera coordinate system or other 3D coordinate systems established by performing coordinate transformation on the camera coordinate system.

In some embodiments, the mapping of the left side 3D mesh and the right side 3D mesh is executed within a preset depth range. In other words, based on the preset depth range, the processor 130 may map the pixels of the left eye image to multiple first 3D coordinates (e.g., camera coordinates) in the 3D coordinate system according to the left eye depth map and camera intrinsic parameters. These first 3D coordinates may constitute the vertices of the left side 3D mesh. Then, during the construction process of the left side 3D mesh, the processor 130 may further combine the relationships of neighboring pixels to generate polygonal mesh surfaces, to fully describe the structure of the left side 3D mesh. In some embodiments, the processor 130 may adopt a similar method to generate the right side 3D mesh.

In some embodiments, the processor 130 may obtain normalized depth values for each pixel in the left eye image according to the left eye depth map. The processor 130 may adjust the normalized depth values of each pixel based on the preset depth range to generate adjusted depth values. The normalized depth value range in the left eye depth map will be scaled to the preset depth range. Based on the camera intrinsic parameters in the projection parameters and the adjusted depth values of each pixel, the processor 130 may project each left eye pixel to the 3D coordinate system, generating multiple first 3D coordinates corresponding to multiple left eye pixels respectively. In some embodiments, the processor 130 may adopt a similar method to map multiple pixels of the right eye image to multiple second 3D coordinates in a 3D coordinate system.

Specifically, based on the reverse projection principle of the Pinhole Camera Model, the processor 130 requires the camera intrinsic parameters and the depth information of pixels to project the pixels from the left eye image and right eye image to the 3D coordinate system. The camera intrinsic parameters may be a camera intrinsic parameter matrix, and include focal length information in the x-axis and y-axis directions on the image plane and the position of the principle point.

Specifically, the processor 130 may project the pixels from the left eye image and right eye image to the 3D coordinate system according to the following formulas (2) to (4).

$${z}^{′} = {z}_{near} + ( {z}_{far} − {z}_{near} ) z \qquad Formula ( 2 )$$

$${x}^{′} = ( x − {c}_{x} ) \frac{{z}^{′}}{{f}_{x}} \qquad Formula ( 3 )$$

$${y}^{′} = ( y − {c}_{y} ) \frac{{z}^{′}}{{f}_{y}} \qquad Formula ( 4 )$$

wherein Zₙₑₐᵣ represents the near planar scene depth; Z_{far} represents the far planar scene depth; z represents the normalized depth value generated by monocular depth estimation; z′ represents the adjusted depth value; fx and fy represent the focal lengths in the x-axis and y-axis directions on the image plane in the camera intrinsic parameter matrix; cx and cy represent the coordinates of the principle point on the image plane. The processor 130 may project the pixels (x,y) from the left eye image to the first 3D coordinates (x′,y′,z′) in the 3D coordinate system according to formulas (2) to (4). The processor 130 may project the pixels (x,y) from the right eye image to the second 3D coordinates (x′,y′,z′) in the 3D coordinate system according to formulas (2) to (4).

In step S350, the processor 130 may generate a 3D scene mesh based on the stereo depth information, the left 3D mesh and the right 3D mesh. In some embodiments, the processor 130 may map the left 3D mesh and the right 3D mesh to the world coordinate system respectively, ensuring consistent coordinate references for both. This mapping process combines the camera extrinsic parameters (rotation matrix R and translation vector T) to convert the vertices in the 3D coordinate system to a unified world coordinate system, as shown in the following formula (5).

$${P}_{world} = R \cdot {P}_{camera} + T \qquad Formula ( 5 )$$

wherein P_{camera} represents the first 3D coordinates of the left 3D mesh or the second 3D coordinates of the right 3D mesh, and P_{world} represents the mapped world coordinates.

Next, the processor 130 may perform vertex matching and depth integration based on the world coordinates of the mapped left 3D mesh and the world coordinates of the right 3D mesh to generate a 3D scene mesh. The 3D scene mesh generated by the processor 130 may include complete vertices, mesh surfaces, depth data and texture mapping information, which can support subsequent 3D scene visualization operations.

In some embodiments, the stereo depth information generated based on binocular depth estimation may be used to calibrate the depth component of the first 3D coordinates of the left 3D mesh and the depth component of the second 3D coordinates of the right 3D mesh. Alternatively, in some embodiments, the stereo depth information generated based on binocular depth estimation may be used to perform weighted calculations with the depth component of the first 3D coordinates and the depth component of the second 3D coordinates of the right 3D mesh, thereby producing the depth of each vertex in the 3D scene mesh.

In step S360, the processor 130 may output 3D scene content according to the 3D scene mesh. The processor 130 may convert the generated 3D scene mesh into a format suitable for display or further processing, and adjust the output content according to application requirements to meet different scene needs. For instance, the processor 130 may convert the 3D scene mesh into a two-dimensional rendered screen of a single viewpoint based on a specific viewing angle. Alternatively, the processor 130 may generate two images of left eye viewpoint and right eye viewpoint according to the 3D scene mesh, allowing the user to experience a stereo visual effect.

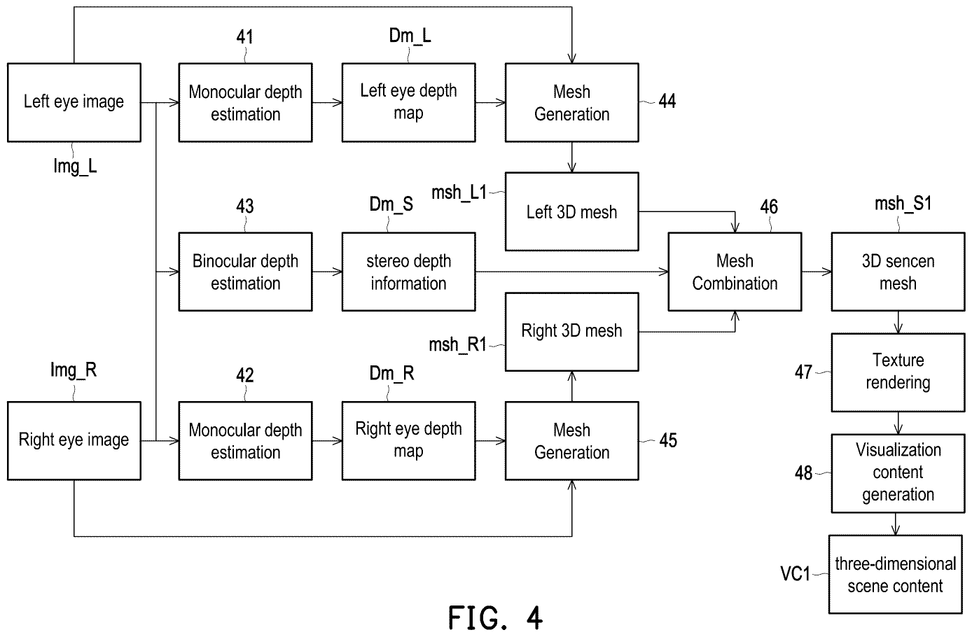

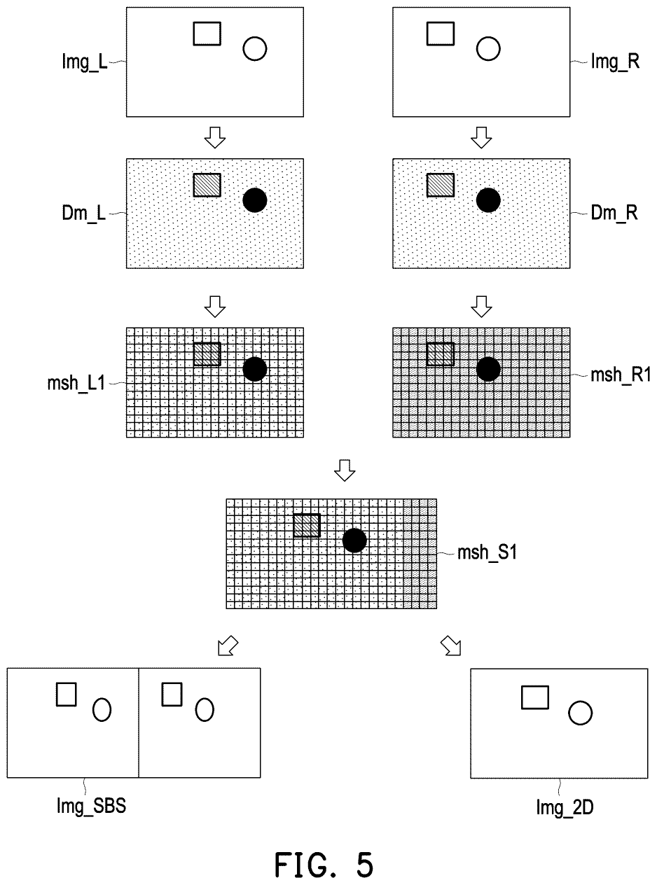

FIG. 4 is a schematic diagram of a 3D scene visualization method according to an embodiment of the present disclosure. FIG. 5 is a schematic diagram of generating 3D scene content according to left eye image and right eye image according to an embodiment of the present disclosure. Please refer to FIG. 4 and FIG. 5 together.

In operation 41, the processor 130 may perform monocular depth estimation on the left eye image Img_L to generate a left eye depth map Dm_L. In operation 42, the processor 130 may perform monocular depth estimation on the right eye image Img_R to generate a right eye depth map Dm_R. In operation 43, the processor 130 may perform binocular depth estimation based on the left eye image Img_L and the right eye image Img_R to generate stereo depth information Dm_S.

In operation 44, the processor 130 may map the left eye image Img_L to 3D coordinates according to the preset depth range and the left eye depth map Dm_L to generate a left 3D mesh msh_L1. In operation 45, the processor 130 may map the right eye image Img_R to 3D coordinates according to the preset depth range and the right eye depth map Dm_R to generate a right 3D mesh msh_R1.

In operation 46, the processor 130 may perform mesh combination according to the stereo depth information Dm_S, the left 3D mesh msh_L1 and the right 3D mesh msh_R1 to generate a 3D scene mesh msh_S1.

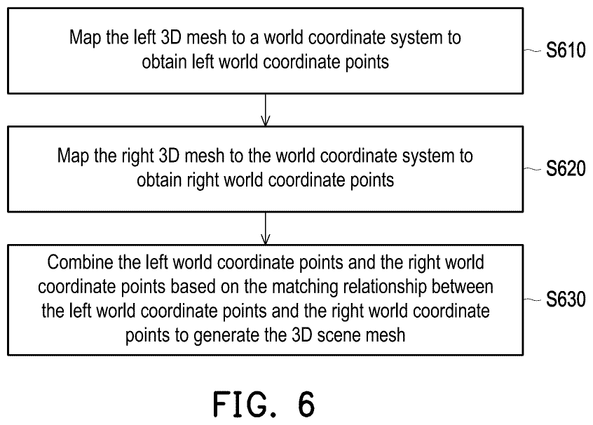

Specifically, referring to FIG. 6, which is a flowchart of generating a 3D scene mesh according to an embodiment of the present disclosure. In step S610, the processor 130 may map the left 3D mesh msh_L1 to a world coordinate system to obtain multiple left world coordinate points. In some embodiments, by utilizing the camera extrinsic parameters of the left lens, the processor 130 may convert the left stereo vertices in the camera coordinate system (i.e., 3D coordinate system) to a unified world coordinate system.

In step S620, the processor 130 may map the right 3D mesh msh_R1 to the world coordinate system to obtain multiple right world coordinate points. In some embodiments, by utilizing the camera extrinsic parameters of the right lens, the processor 130 may convert the right stereo vertices in the camera coordinate system (i.e., 3D coordinate system) to a unified world coordinate system.

In step S630, the processor 130 may combine multiple left world coordinate points and multiple right world coordinate points based on the matching relationship between the left world coordinate points and the right world coordinate points to generate the 3D scene mesh msh_S1. Specifically, in the matching process, the processor 130 may need to determine which left world coordinate points and right world coordinate points correspond to the same scene point, in order to generate a vertex in the 3D scene mesh msh_S1 according to a left world coordinate point and a right world coordinate point corresponding to the same scene point.

In some embodiments, when the Euclidean distance between a first left world coordinate point and a first right world coordinate point is less than a matching distance threshold, the processor 130 may match the first left world coordinate point with the first right world coordinate point. The first left world coordinate point and first right world coordinate point matched with each other may be combined to generate a vertex in the 3D scene mesh msh_S1.

In some embodiments, the processor 130 may perform an average operation or a weighted operation on the X coordinate component of the first left world coordinate point and the X coordinate component of the first right world coordinate point to generate the X coordinate component of a vertex in the 3D scene mesh msh_S1. The processor 130 may perform an average operation or a weighted operation on the Y coordinate component of the first left world coordinate point and the Y coordinate component of the first right world coordinate point to generate the Y coordinate component of a vertex in the 3D scene mesh msh_S1.

In some embodiments, since the left eye image Img_L and the right eye image Img_R correspond to different viewpoints, some scene points in the scene may only exist in the left eye image Img_L or the right eye image Img_R due to the Occlusion Effect. In other words, a right world coordinate point of the right 3D mesh msh_R1 may not be able to match any left world coordinate point of the left 3D mesh msh_L1. Alternatively, a left world coordinate point of the left 3D mesh msh_L1 may not be able to match any right world coordinate point of the right 3D mesh msh_R1. In this case, the processor 130 may directly retain the unmatched right world coordinate point or the unmatched left world coordinate point in the 3D scene mesh msh_S1. For example, multiple left world coordinate points in the left edge area of the left 3D mesh msh_L1 may be directly retained in the 3D scene mesh msh_S1. Multiple right world coordinate points in the right edge area of the right 3D mesh msh_R1 may be directly retained in the 3D scene mesh msh_S1.

In some embodiments, the processor 130 may use stereo depth information to calibrate depth deviation between the left world coordinate points and the right world coordinate points. Specifically, due to inconsistencies in content between the left eye image Img_L and the right eye image Img_R, there exists depth deviation between the right eye depth map Dm_R and the left eye depth map Dm_L generated by the monocular depth estimation model. That is, the depth value “100” in the right eye depth map Dm_R and the depth value “100” in the left eye depth map Dm_L actually correspond to different real scene depths. Therefore, the processor 130 may use the stereo depth information Dm_S to calibrate the depth deviation between multiple left world coordinate points and multiple right world coordinate points, so that the depth values in the 3D scene mesh msh_S1 can be more accurate.

In some embodiments, the processor 130 may perform a weighted operation on the depth components of a matched right world coordinate point and left world coordinate point, as well as the depth value in the stereo depth information Dm_S, to generate the depth component of a vertex in the 3D scene mesh msh_S1.

In some embodiments, the processor 130 may calculate depth difference information between the stereo depth information Dm_S and the left eye depth map Dm_L to generate a left depth scale transformation function. The processor 130 may adjust all depth components of the left 3D mesh msh_L1 according to the left depth scale transformation function. In some embodiments, the processor 130 may calculate depth difference information between the stereo depth information Dm_S and the right eye depth map Dm_R to generate a right depth scale transformation function. The processor 130 may adjust all depth components of the right 3D mesh msh_R1 according to the right depth scale transformation function. Afterwards, the processor 130 may perform an averaging operation or a weighted operation on the scaled and adjusted depth components in the left 3D mesh msh_L1 and the scaled and adjusted depth components in the right 3D mesh msh_R1 to generate the depth component of a vertex in the 3D scene mesh msh_S1.

In some embodiments, the processor 130 may set the near planar scene depth z_{min,L} and far planar scene depth z_{max,L} of the left 3D mesh msh_L1, and the near planar scene depth z_{min,R} and far planar scene depth z_{max,R} of the right 3D mesh msh_R1 as optimization target parameters. Using an optimization algorithm (for example, gradient descent algorithm), the processor 130 may obtain the optimal solutions for the near planar scene depth z_{min,L}, far planar scene depth z_{max,L}, near planar scene depth z_{min,R}, and far planar scene depth z_{max,R} according to the left eye image Img_L, right eye image Img_R, and stereo depth information Dm_S.

The gradient descent algorithm, as a numerical optimization method, is suitable for solving non-linear problems with multiple unknown parameters. In these embodiments, the processor 130 first sets initial depth range parameters (i.e., initial values for the near planar scene depth z_{min,L}, far planar scene depth z_{max,L}, near planar scene depth z_{min,R}, and far planar scene depth z_{max,R}). Then, the processor 130 may calculate the corresponding left pixel plane coordinates and right pixel plane coordinates for the same stereo scene coordinate point based on the depth range parameters, as in formula (6) and formula (7), where the stereo scene coordinate point may be calculated based on the stereo depth information Dm_S.

$${u}_{i , L} = \frac{f \cdot {x}_{i} + IPD / 2}{{z}_{i}} = \frac{f \cdot {x}_{i} + IPD / 2}{{z}_{min , L} + ( {z}_{min , L} − {z}_{min , L} ) {d}_{i , L}} \qquad Formula ( 6 )$$

$${u}_{i , R} = \frac{f \cdot {x}_{i} + IPD / 2}{{z}_{i}} = \frac{f \cdot {x}_{i} + IPD / 2}{{z}_{min , R} + ( {z}_{min , R} − {z}_{min , R} ) {d}_{i , R}} \qquad Formula ( 7 )$$

Wherein f represents the camera focal length, IPD represents the baseline distance of the camera (the distance between the left and right cameras), xᵢ represents the X coordinate of the stereo scene coordinate, and d_{i,L} represents the depth value of the left eye depth map, d_{i,R} represents the depth value of the right eye depth map, i represents the vertex index. u_{i,L} represents the X coordinate of the left pixel plane coordinate, u_{i,R} represents the X coordinate of the right pixel plane coordinate.

Afterwards, the processor 130 may calculate an error value based on the color of the left pixel plane coordinate in the left eye image Img_L and the color of the right pixel plane coordinate in the right eye image Img_R. Through multiple iterations, gradient descent gradually updates the parameter values to minimize the aforementioned error value, until it converges to a preset threshold or reaches the maximum number of iterations.

In this way, the processor 130 may calculate the left depth scale transformation function according to the near planar scene depth z_{min,L}, far planar scene depth z_{max,L}, and the minimum scene depth and maximum scene depth in the stereo depth information Dm_S. The processor 130 may calculate the right depth scale transformation function according to the near planar scene depth z_{min,R}, far planar scene depth z_{max,R}, and the minimum scene depth and maximum scene depth in the stereo depth information Dm_S.

Alternatively, in some embodiments, the processor 130 may calculate a first depth average of depth values within the near-field distance range (i.e., zₘᵢₙ to zₘᵢₙ+Δz) in the stereo depth information Dm_S, and calculate a second depth average of depth values within the far-field distance range (i.e., zₘₐₓ−Δz to zₘₐₓ) in the stereo depth information Dm_S. Furthermore, the processor 130 may calculate a third depth average of depth values within the near-field distance range in the right 3D mesh msh_R1, and calculate a fourth depth average of depth values within the far-field distance range in the right 3D mesh msh_R1. Thus, the processor 130 may establish the right depth scale transformation function based on the scaling ratio between the first depth average and the third depth average, as well as the scaling ratio between the second depth average and the fourth depth average. Similarly, the processor 130 may calculate a fifth depth average of depth values within the near-field distance range in the left 3D mesh msh_L1, and calculate a sixth depth average of depth values within the far-field distance range in the left 3D mesh msh_L1. Thus, the processor 130 may establish the left depth scale transformation function based on the scaling ratio between the first depth average and the fifth depth average, as well as the scaling ratio between the second depth average and the sixth depth average. The right depth scale transformation function and the left depth scale transformation function may be used to calibrate the depth of the right 3D mesh msh_R1 and the depth of the left 3D mesh msh_L1, respectively.

In other words, the stereo depth information Dm_S serves as the base data, helping to generate an accurate 3D scene mesh msh_S1, and ensuring that the vertex positions in the 3D scene mesh msh_S1 are consistent with the actual scene.

Returning to FIG. 4, in operation 47, the processor 130 may perform texture rendering on the 3D scene mesh msh_S1. Specifically, the processor 130 may render textures on each vertex in the 3D scene mesh msh_S1 according to the texture information of the left eye image Img_L and the texture information of the right eye image Img_R.

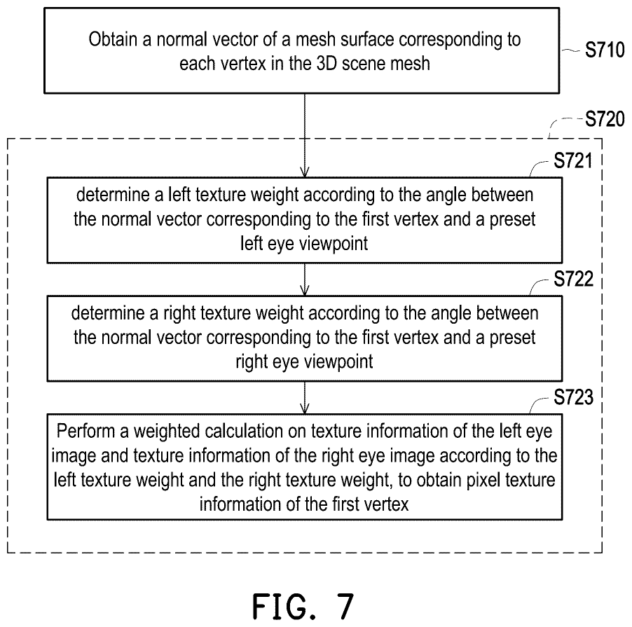

Specifically, referring to FIG. 7, which is a flowchart of determining texture information according to the disclosed implementation. In step S710, the processor 130 may obtain the normal vector of the mesh surface corresponding to each vertex in the 3D scene mesh msh_S1. In step S720, the processor 130 may determine the pixel texture information for each vertex according to the normal vector corresponding to each vertex, the preset left eye viewpoint, and the preset right eye viewpoint. By comparing the directional similarity between the normal vector corresponding to each vertex and the preset left eye viewpoint, and the directional similarity between the normal vector corresponding to each vertex and the preset right eye viewpoint, the processor 130 may determine whether to use the texture information from the left eye image Img_L or the right eye image Img_R. For example, when the directional similarity between the normal vector corresponding to a certain vertex and the preset left eye viewpoint is higher, the processor 130 may directly use the texture information of the corresponding pixel in the left eye image Img_L as the texture information for that vertex. Alternatively, when the directional similarity between the normal vector corresponding to a certain vertex and the preset right eye viewpoint is higher, the processor 130 may multiply the texture information of the corresponding pixel in the left eye image Img_L by a larger weight and multiply the texture information of the corresponding pixel in the right eye image Img_L by a smaller weight to generate the texture information for that vertex.

In some implementations, the processor 130 may determine to select texture from the left or right image according to the angle between the normal vector direction and the virtual camera line of sight. In some implementations, the processor 130 may set up a weight function to dynamically adjust texture selection.

In some implementations, each vertex in the 3D scene mesh msh_S1 may be associated with multiple mesh surfaces, and the processor 130 may select one of the normal vectors of these mesh surfaces to determine the texture information. Alternatively, in some implementations, each vertex in the 3D scene mesh msh_S1 may be associated with multiple mesh surfaces, and the processor 130 may choose to perform a summation process on these normal vectors of these mesh surfaces to determine the texture information based on this summed normal vector.

In some implementations, step S720 may be implemented as steps S721 to S723. In step S721, the processor 130 may determine the left texture weight according to the angle between the normal vector corresponding to the first vertex and the preset left eye viewpoint. In step S722, the processor 130 may determine the right texture weight according to the angle between the normal vector corresponding to the first vertex and the preset right eye viewpoint. In step S723, the processor 130 may perform a weighted calculation on the texture information of the left eye image Img_L and the texture information of the right eye image Img_R according to the left texture weight and the right texture weight, to obtain the pixel texture information of the first vertex.

For example, the processor 130 may determine the pixel texture information of the first vertex according to the following formula (8).

$${I}_{x , y} = f ( {n}_{x , y , z} \cdot {d}_{l} ) {L}_{x , y} + g ( {n}_{x , y , z} \cdot {d}_{r} ) {R}_{x , y} \qquad formula ( 8 )$$

Where, I_{x,y} represents the pixel texture information of the first vertex; L_{x,y} represents the texture information of the left eye image Img_L; R_{x,y} represents the texture information of the right eye image Img_R; n_{x,y,z} represents the normal vector corresponding to the first vertex; dₗ represents the preset left eye viewpoint; and dᵣ represents the preset right eye viewpoint. The processor 130 may calculate the inner product of n_{x,y,z} and dₗ, which represents the angle information between the normal vector and the preset left eye viewpoint. The processor 130 may calculate the inner product of n_{x,y,z} and dᵣ, which represents the angle information between the normal vector and the preset right eye viewpoint. The right texture weight equals g(n_{x,y,z}·dᵣ). The left texture weight equals f(n_{x,y,z}·dₗ). g(·) is a preset function, and f(·) is another preset function.

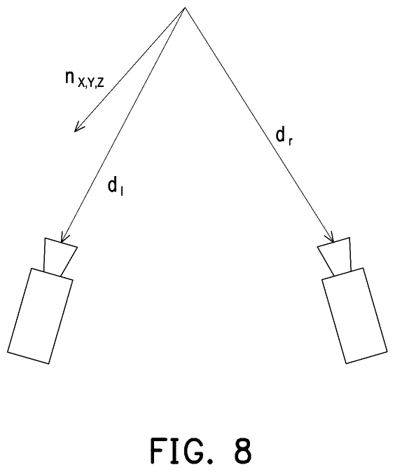

For example, FIG. 8 is a schematic diagram illustrating the decision of texture information according to an implementation of the disclosure. Referring to FIG. 8, the processor 130 may calculate the inner product of n_{x,y,z} and dₗ, which represents the angle information between the normal vector and the preset left eye viewpoint. The processor 130 may calculate the inner product of n_{x,y,z} and dᵣ, which represents the angle information between the normal vector and the preset right eye viewpoint. In this example, the angle between n_{x,y,z} and dₗ is smaller, so the left texture weight is greater than the right texture weight.

Returning to FIG. 4, in operation 48, the processor 130 may perform visualization content generation based on the 3D scene mesh msh_S1 with texture information, to output the 3D scene content VC1. In the example of FIG. 5, the 3D scene content VC may include a side-by-side image Img_SBS of different viewpoint contents or a two-dimensional rendered screen Img_2D corresponding to a specific viewpoint.

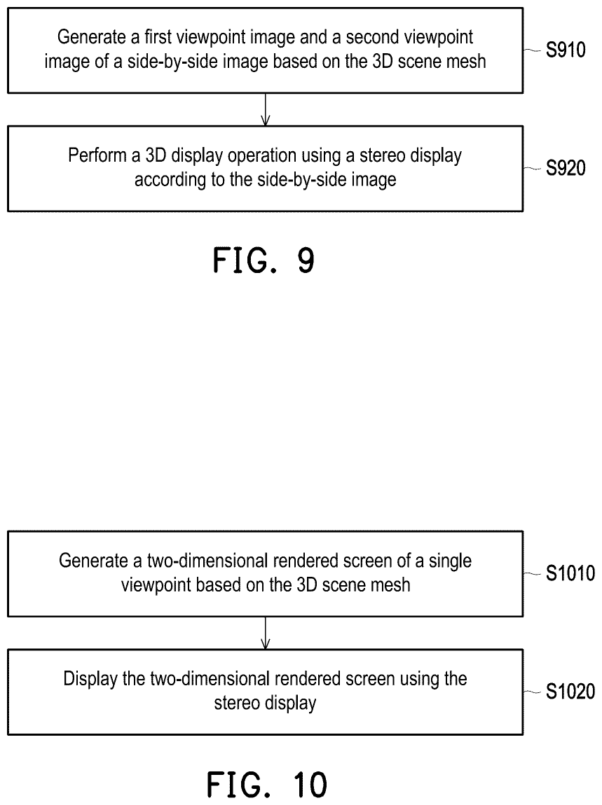

Referring to FIG. 9, which is a flowchart of outputting 3D scene content according to an implementation of the disclosure. In step S910, the processor 130 may generate a first viewpoint image and a second viewpoint image of a side-by-side image Img_SBS based on the 3D scene mesh msh_S1. In step S920, the processor 130 may perform a 3D display operation using a stereo display 110 according to the side-by-side image Img_SBS.

Specifically, the processor 130 may generate the first viewpoint image and the second viewpoint image based on multiple scene 3D coordinates in the 3D scene mesh msh_S1, and generate the side-by-side image Img_SBS according to the first viewpoint image and the second viewpoint image. Subsequently, the processor 130 may perform a 3D display operation using a stereo display 110 according to the side-by-side image.

In some implementations, the processor 130 may perform pinhole projection on the 3D scene mesh msh_S1 according to the user input interpupillary distance (i.e., the distance between two virtual cameras) to generate the first viewpoint image and the second viewpoint image. In some implementations, the processor 130 may dynamically determine the interpupillary distance (i.e., the distance between two virtual cameras) according to the scene content, to perform pinhole projection on the 3D scene mesh msh_S1 based on the aforementioned interpupillary distance, and finally generate the first viewpoint image and the second viewpoint image. For example, when the scene content includes close-range objects, the processor 130 may reduce the distance between two virtual cameras to reduce user visual stress. When the scene content is a distant view content, the processor 130 may increase the distance between two virtual cameras to enhance the stereo sensation.

In some implementations, the processor 130 may control the stereo display 110 to operate in a stereo display mode to display the side-by-side image Img_SBS including the first viewpoint image and the second viewpoint image. Specifically, when the stereo display 110 is an naked-eye stereoscopic display, the processor 130 may perform image interleaving processing on the side-by-side image Img_SBS to obtain an interlaced image, where this image interleaving processing arranges the left eye image pixels and right eye image pixels of the side-by-side image Img_SBS alternately in the interlaced frame. Subsequently, when the stereo display 110 operates in the stereo display mode, the display panel 111 of the stereo display 110 will display the interlaced image, and the refraction function of the lens layer 112 of the stereo display 110 is enabled, causing the viewer to perceive a stereoscopic visual effect.

Referring to FIG. 10, which is a flowchart of outputting 3D scene content according to an implementation of the disclosure. In step S1010, the processor 130 may generate a two-dimensional rendered screen of a single viewpoint based on the 3D scene mesh msh_S1. In step S1020, the processor 130 may display the two-dimensional rendered screen using a stereo display 110. In some implementations, the processor 130 may control the stereo display 110 to operate in a two-dimensional display mode to display the two-dimensional rendered screen. Furthermore, the processor 130 may determine a specific viewing viewpoint according to user input, and perform pinhole projection on the 3D scene mesh msh_S1 based on this specific viewing viewpoint to generate the two-dimensional rendered screen. In other words, the user may view screens from different viewpoints by controlling the specific viewing viewpoint.

In summary, in the implementations of the disclosure, the 3D scene mesh may be generated based on the depth estimation results of monocular depth estimation and the stereo depth information of the stereo image pair. Therefore, monocular depth estimation may be used to compensate for the occlusion and texture repetition issues in binocular depth estimation, and the stereo depth information of the stereo image pair may be used to optimize the estimation results of monocular depth estimation. Based on this, the 3D scene mesh generated from monocular depth estimation and stereo depth information of the stereo image pair not only allows users to perceive depth of field that matches the scene type, but also realizes high-precision, flexible, and efficient 3D scene generation and visualization. The implementation of the disclosure proposes a method for generating 3D scene mesh that combines monocular depth estimation with stereo depth information, overcoming the inherent limitations of binocular depth estimation through complementary optimization techniques, while improving the accuracy and stability of monocular depth estimation.

What is claimed is:

1. A three-dimensional (3D) scene visualization method, comprising:
obtaining a left eye image and a right eye image from a stereo image pair;
performing monocular depth estimation on the left eye image and the right eye image respectively to obtain a left eye depth map and a right eye depth map;
generating a stereo depth information according to disparity information between the left eye image and the right eye image;
generating a left side 3D mesh of the left eye image based on the left eye depth map, and generating a right side 3D mesh of the right eye image based on the right eye depth map;
generating a 3D scene mesh according to the stereo depth information, the left side 3D mesh and the right side 3D mesh; and
outputting 3D scene content according to the 3D scene mesh.

2. The 3D scene visualization method as claimed in claim 1, wherein the step of performing the monocular depth estimation on the left eye image and the right eye image respectively to obtain the left eye depth map and the right eye depth map comprises:
inputting the left eye image into a monocular depth estimation model to obtain the left eye depth map; and
inputting the right eye image into the monocular depth estimation model to obtain the right eye depth map.

3. The 3D scene visualization method as claimed in claim 1, wherein the step of generating the left side 3D mesh of the left eye image based on the left eye depth map, and generating the right side 3D mesh of the right eye image based on the right eye depth map comprises:
mapping a plurality of pixels of the left eye image to a plurality of first 3D coordinates in a 3D coordinate system according to camera intrinsic parameters and the left eye depth map, to construct the left side 3D mesh of the left eye image; and
mapping a plurality of pixels of the right eye image to a plurality of second 3D coordinates in the 3D coordinate system according to the camera intrinsic parameters and the right eye depth map, to construct the right side 3D mesh of the right eye image.

4. The 3D scene visualization method as claimed in claim 3, wherein the mapping of the left side 3D mesh and the right side 3D mesh is executed based on a preset depth range.

5. The 3D scene visualization method as claimed in claim 1, wherein the step of generating the 3D scene mesh according to the stereo depth information, the left side 3D mesh and the right side 3D mesh comprises:
mapping the left side 3D mesh to a world coordinate system to obtain a plurality of left side world coordinate points;
mapping the right side 3D mesh to the world coordinate system to obtain a plurality of right side world coordinate points; and
combining the plurality of left side world coordinate points and the plurality of right side world coordinate points based on matching relationship between the plurality of left side world coordinate points and the plurality of right side world coordinate points, to generate the 3D scene mesh.

6. The 3D scene visualization method as claimed in claim 5, wherein the step of combining the plurality of left side world coordinate points and the plurality of right side world coordinate points based on the matching relationship between the plurality of left side world coordinate points and the plurality of right side world coordinate points, to generate the 3D scene mesh comprises:
calibrating depth deviation between the plurality of left side world coordinate points and the plurality of right side world coordinate points using the stereo depth information.

7. The 3D scene visualization method as claimed in claim 1, wherein the step of generating the 3D scene mesh according to the stereo depth information, the left side 3D mesh and the right side 3D mesh comprises:
obtaining a normal vector of a mesh surface corresponding to each vertex in the 3D scene mesh; and
determining pixel texture information for each vertex according to the normal vector corresponding to each vertex, preset left eye viewpoint and preset right eye viewpoint.

8. The 3D scene visualization method as claimed in claim 7, wherein the step of determining the pixel texture information for each vertex according to the normal vector corresponding to each vertex, the preset left eye viewpoint and the preset right eye viewpoint comprises:
determining a left side texture weight according to an angle between the normal vector corresponding to a first vertex and the preset left eye viewpoint;
determining a right side texture weight according to an angle between the normal vector corresponding to the first vertex and the preset right eye viewpoint; and
performing weighted calculation on texture information of the left eye image and texture information of the right eye image according to the left side texture weight and the right side texture weight, to obtain the pixel texture information of the first vertex.

9. The 3D scene visualization method as claimed in claim 1, wherein the step of outputting 3D scene content according to the 3D scene mesh comprises:
generating a two-dimensional rendered screen of a single viewpoint according to the 3D scene mesh; and
displaying the two-dimensional rendered screen using a display device.

10. The 3D scene visualization method as claimed in claim 1, wherein the step of outputting 3D scene content according to the 3D scene mesh comprises:
generating a first viewpoint image and a second viewpoint image of a side-by-side image according to the 3D scene mesh; and
performing a 3D display operation according to the side-by-side image using a stereo display device.

11. A stereo image display system, comprising:
a stereo display device; and
at least one processor, coupled to the stereo display device, and configured to:
obtain a left eye image and a right eye image from a stereo image pair;
perform monocular depth estimation on the left eye image and the right eye image respectively to obtain a left eye depth map and a right eye depth map;
generate a stereo depth information according to disparity information between the left eye image and the right eye image;
generate a left side 3D mesh of the left eye image based on the left eye depth map, and generating a right side 3D mesh of the right eye image based on the right eye depth map;
generate a 3D scene mesh according to the stereo depth information, the left side 3D mesh and the right side 3D mesh; and
output 3D scene content according to the 3D scene mesh.
